(19) United States
(12) Patent Application Publication
(10) Pub. No.: US 2019/0024592 A1
(43) Pub. Date: Jan. 24, 2019

(54) SPRING RETURN THROTTLE ACTUATOR, METHOD OF CONTROL THEREOF AND THROTTLE ASSEMBLY

(71) Applicant: Scania CV AB, Södertälje (SE)

(72) Inventors: Fredrik STRÅÅT, Stockholm (SE); Sebastian ZAMANI, Stockholm (SE)

(73) Assignee: Scania CV AB, Södertälje (SE)

(21) Appl. No.: 16/066,611

(22) PCT Filed: Dec. 12, 2016
(86) PCT No.: PCT/SE2016/051245

§ 371 Date: Jun. 27, 2018

(30) Foreign Application Priority Data
Jan. 5, 2016 (SE) 1650010-0

(51) Int. Cl. F02D 9/10; F02D 11/10; F16K 31/04; F16K 37/00; H02P 6/17; H02P 6/182

(52) U.S. Cl. CPC F02D 9/1065; F02D 11/107; F16K 31/042; F16K 31/043; F02D 2009/0213; F16K 37/0041; H02P 6/17; H02P 6/182; F16K 37/0033

(57) ABSTRACT

A spring return throttle actuator including: an electric, plural-coil DC motor having an output shaft, a throttle return spring, a gear transmission connected to the output shaft, a control unit adapted to control power supply to the DC motor, wherein the spring return throttle actuator has a movement range between closed throttle and fully opened throttle. The control unit includes a monitoring circuit adapted to monitor DC motor movement. The monitoring circuit is configured to receive signals from at least one voltage sensor adapted to sense voltage induced in at least one of the DC motor coils during a spring forced return of the throttle, and the monitoring circuit is configured to create a representation of DC motor movement based on said signals.

### CROSS-REFERENCE TO RELATED APPLICATION(S)

This application is a National Stage Application (filed under 35 § U.S.C. 371) of PCT/SE2016/051245, filed Dec. 12, 2016 of the same title, which, in turn claims priority to Swedish Application No. 1650010-0 filed Jan. 5, 2016 of the same title; the contents of each of which are hereby incorporated by reference.

### FIELD OF THE INVENTION

The invention relates to a spring return throttle actuator including: an electric, plural-coil, DC motor having an output shaft, a throttle return spring, a gear transmission connected to the output shaft, a control unit adapted to control power supply to the DC motor, wherein the actuator has a movement range between closed throttle and fully opened throttle. The invention also relates to a method for control thereof and a throttle assembly.

### BACKGROUND OF THE INVENTION

Throttle assemblies are employed to control gas streams in respect of vehicle engines. The actuator DC motor is typically supplied with an electric current to switch from a normally open to a closed throttle position or from a normally closed to an open throttle position.

It could be mentioned that in respect of for example an air inlet throttle valve, the throttle is normally open whereas in an EGR valve the throttle is normally closed.

As a rule, the return spring tends to move the throttle to a determined “normal” position which will guarantee operation also in the event that the DC motor is without current. It is thereby an aim to maintain the required exhaust gas values etc.

In a background art throttle assembly, for reaching intermediate positions between closed throttle and fully opened throttle, the DC motor is supplied with current to create a dynamic electromotive force which, by virtue of the control unit, balances the spring force to obtain a desired stationary throttle position between closed throttle and fully open throttle.

It is previously known that there are occasionally problems with throttles for example because of mechanical deficiencies or some sort of obstruction preventing unrestricted movement of the throttle. This might depend on the formation of ice or the accumulation of dirt around the seat of the throttle or in throttle shaft bearings, or a defective spring which for example has been damaged and obtained unwanted properties.

The throttle can hereby be impossible or difficult to move properly and at proper speed over the whole or part of its movement range which is detrimental to the operation of the vehicle. It is, however, difficult to determine in what way the throttle assembly is defective. Also relatively small influences on throttle movements may impair engine control.

### SUMMARY OF THE INVENTION

It is an aim of the present invention to provide a throttle actuator according to the above wherein the problems of the background art are addressed and at least reduced. This aim is obtained in a throttle actuator according to the above in that
that the control unit includes a monitoring circuit adapted to monitor DC motor movement,
that the monitoring circuit is arranged to receive signals from at least one voltage sensor adapted to sense voltage induced in at least one of the DC motor coils during a spring forced return of the throttle, and
that the monitoring circuit is arranged to create a representation of DC motor movement based on said signals.

For analyzing the condition of the return spring, the spring is typically tensioned maximally whereupon the system is made currentless, that means that the electric supply to the motor is interrupted. Thereupon the throttle together with the motor is returned to the “normal” position by the spring force. The time for the spring to press the throttle all the way back to that normal position will be a measurement describing whether the spring or anything else in the mechanics is jammed or defective or if anything restricts the movement. At the same time, induced voltage will be measured.

The obtained value describes the resist electromotive force generated by the electric motor when driven by an external force in the form of the return spring. Since said force in turn is depending on the rotational speed of the rotor of the actuator motor, it can hereby be established how fast the throttle moves. From that information it is possible to analyze the nature of the defect, if any, that the return spring is suffering from.

It is also possible, in a simple embodiment, to set accept limits for momentary rotational speed as a function of time wherein values outside the limits are considered to indicate defects.

A representation of DC motor movement is of course dependent on throttle movement and can be any one of throttle speed and throttle position. It can also simply be a sampled voltage value or a momentary voltage amplitude value describing DC motor speed.

A throttle with defective return spring might either move with more or less constant speed against a restriction or move unrestricted over part or parts of its range and move with restricted speed in intermediate range part or parts. These two scenarios can quite well give the same total time delay but has completely different basic background.

For that reason, it is advantageously preferred that the voltage sensor is arranged to measure the induced voltage momentarily since this allows the monitoring circuit to produce a momentary representation of the amplitude thereby giving more advanced analyzing possibilities to more exactly diagnose what damage the spring suffers from.

One advantage here is thus the capability to provide a more detailed picture of an existing defect. A measured speed profile of the throttle can be compared to a plurality of stored throttle rotational speed profiles representing different kinds of defects so as to be coupled to one of them.

It is also possible to compare measured angular throttle position as a function of time to stored throttle position profiles. Such values are obtainable through conventional signal processing and derivable from measured voltage.

The results can in all cases be displayed to the operator visually on a screen and/or be signaled as return spring condition message, a light or a sound signal, particularly in the event that a defect has been detected.

Knowledge of prevailing throttle movement parameters can even be used for adapting possible control algorithms in the vehicle to adapt engine control to the prevailing problem in order to reduce impact of the defect.

The DC Motor Advantageously Includes Three Coils but May Also Include More than Three Coils.

The control unit preferably includes a bridge circuit having one branch connected to each one of the coils. Measuring induced voltage is then advantageously performed in relation to one of the branches. Each branch suitably includes a transistor switch connected to each one of the coils.

The invention also relates to a method of controlling a spring return throttle actuator, said actuator including: an electric, plural-coil, DC motor having an output shaft, a throttle return spring, a gear transmission connected to the output shaft, a control unit adapted to control power supply to the DC motor, wherein the actuator has a movement range between closed throttle and fully opened throttle. The movement of the DC motor control unit is monitored by a monitoring circuit. Voltage induced in at least one of the DC motor coils during a spring forced return of the throttle is sensed by a voltage sensor of the monitoring circuit. A representation of DC motor movement is created based on said signals.

Advantages as above are obtained through the inventive method.

The DC motor preferably includes three coils wherein voltage induced in at least one of the DC motor coils is sensed.

The coils are supplied with power from each one branch of a bridge circuit being included in the control unit. In particular, when the coils are supplied with power from each one branch of a bridge circuit being included in the control unit, each branch is advantageously switched through separate transistor switches.

The invention also concerns a throttle assembly including a throttle, a throttle actuator and a control unit, wherein the throttle actuator is according to what is stated above.

Further features of and advantages of the invention will be explained below at the background of embodiments.

### BRIEF DESCRIPTION OF DRAWINGS

The invention will now be described in greater detail by way of embodiments and with reference to the annexed drawings, wherein:

FIG. 1 illustrates a throttle assembly including a spring return throttle actuator according to the invention,

FIG. 2 shows a control circuit for the inventive throttle actuator,

FIG. 3 shows a simplified flow chart over an inventive method,

FIG. 4 shows a diagram over measured voltage as a function of elapsed time, and

FIG. 5 shows a diagram over signal processed momentary rotational speed as a function of elapsed time.

### DETAILED DESCRIPTION OF THE INVENTION

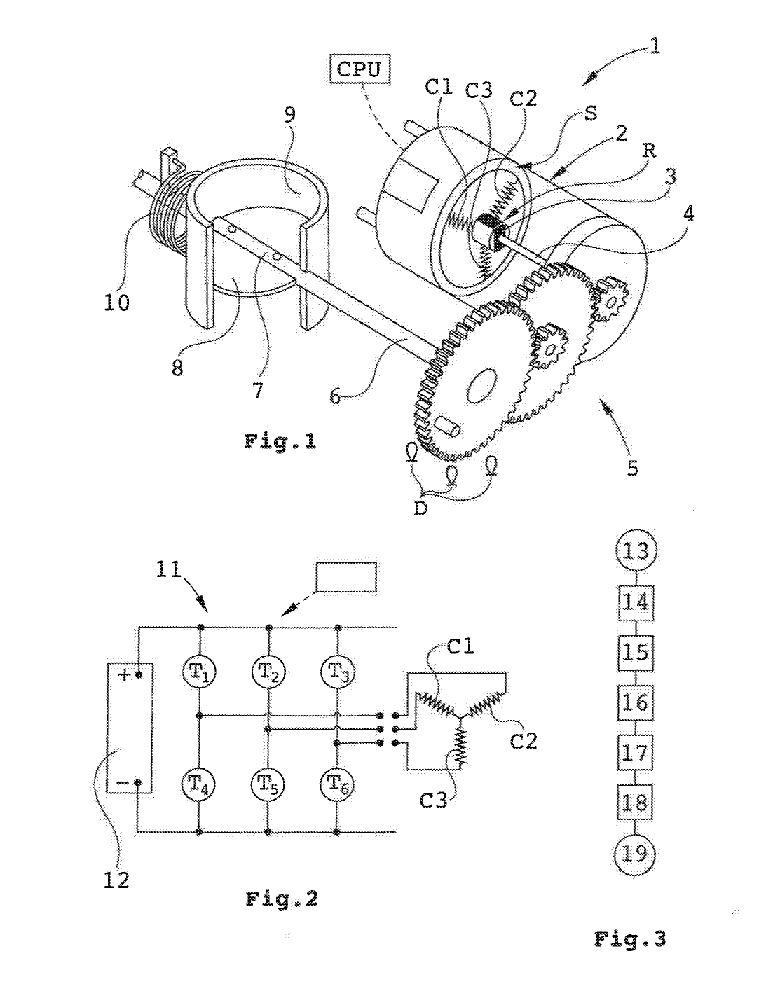

FIG. 1, shows a throttle assembly whereof a spring return throttle actuator is generally depicted with reference number 1. The actuator 1 includes a DC motor 2 having three coils C1, C2 and C3 in its stator S. The rotor R is as usual provided with a permanent rotor magnet 3 and an output shaft 4.

A gear transmission 5 is connected to the output shaft 4 and an outgoing shaft 6 from the gear transmission 5 is coupled with its distal end to a throttle shaft 7 of a throttle 8. The actuator has a movement range between closed throttle and fully opened throttle.

The throttle 8 is arranged in a channel 9 to control a gas stream flowing through the channel 9.

A throttle return spring 10 is positioned around the outgoing shaft 6 and functions to provide a spring torque urging the outgoing shaft 6 to rotate towards a “normal” position of the throttle 8 which may be fully open or fully closed depending on the nature of the throttle as explained above.

A control unit CPU is connected to the DC motor and is adapted to control supply of power to the DC motor and thereby to control the throttle position. Movement sensors, preferably Hall effect sensors, are indicated with D.

FIG. 2 illustrates a bridge circuit 11 positioned between a 24 Volts current source 12 for the supply of power to the three coils C1, C2 and C3 of the DC motor 3. It is to be noted that any suitable voltage can be used.

The bridge circuit includes a set of transistor switches T1-T6 that are made conductive—nonconductive to controllably power supply the DC motor 3.

It is possible to make variations of the duration of conductivity of the transistor switches in order to apply force of different magnitudes by varying and by controlling transistor switches. It is possible to measure voltage in at least one of the conduits connected to the coils. A voltage detector can be active in respect of either one (or more than one) of the conduits associated with the coils C1-C3 and signals therefrom be passed on to the CPU.

It is possible to receive information from the DC motor and associated cables about its operation. If the motor is rotated, the rotational speed is directly proportional to the voltage. It is also possible to measure voltage which momentarily results in knowledge about rotational speed. For detection of rotational position of the rotor of the motor, a plurality of detectors is preferably being used. This gives information about throttle position.

The detectors are suitably stationary and for example co-operating with a ring or part of a ring being rotationally associated with the rotor or with one of the shafts, said ring having a great number of evenly distributed marks or holes. Monitoring the durations between pulses from three distributed mark or hole detectors results in information of position and rotational speed. There is also a possibility to detect rotor acceleration if required for some reason.

In the simplified flow chart in FIG. 3, an exemplary method sequence related to the invention is briefly illustrated.
13 indicates start of sequence.
14 indicates initiating DC motor to position throttle in desired position where the return spring is strained and stretched and verifying that throttle has reached the desired position.
15 indicates cutting current to the DC motor and initiating voltage measuring in at least one of the conduits being connected to the coils.
16 indicates monitoring throttle movements effected by the return spring by voltage measuring.
17 indicates evaluating monitored throttle movement pattern in relation to a stored exemplary movement curve.
18 indicates amending and adapting engine control values to established prevailing throttle actuation conditions.
19 indicates issuing a return spring condition message to the user and ending of sequence.

The sequence may be supplemented with additional steps and is repeated as required.

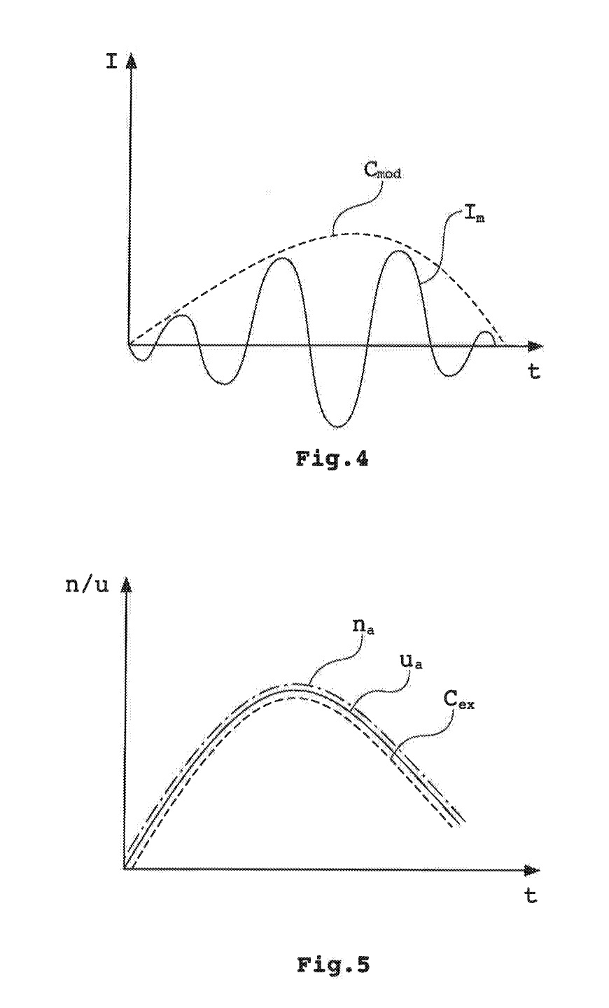

FIG. 4 shows a diagram over measured voltage as a function of elapsed time. The meandering curve, Iₘ, represents momentary voltage signal output from a voltage detector associated with a coil conduit as a function of time (t). C_{mod} represents a modulated curve thereof.

FIG. 5 shows a diagram over signal processed momentary rotational speed (nₐ) and voltage (uₐ) as a function of elapsed time (t). Cₑₓ represents an exemplary stored throttle rotational speed profile. As seen in FIG. 5, the rotational speed (nₐ) and voltage (uₐ) curves in the shown example have good conformity to the exemplary stored throttle rotational speed profile curve Cₑₓ. Hereby the condition of the return spring can be estimated to be as an exemplary return spring condition corresponding to the conforming stored profile. Furthermore, when a plurality of exemplary throttle rotational speed profile curves representing different return spring conditions are stored, the return spring condition is estimated to be as corresponds to the profile curve that most closely conforms to the measured profile.

The invention can be modified within the scope of the annexed claims. For example, the control circuitry can be laid out differently as can be the DC motor, for instance, the number of coils of the DC motor can be other than three.

The feature “closed throttle” is intended to include a case with totally blocked opening as well as a case with a certain minimum opening that might exist. With the feature “opened throttle” is intended the maximum opening achievable for the throttle in question.

Different kinds of sensors may be employed and they can be positioned in various places in association with the throttle assembly, for example close to the throttle itself.

1. A spring return throttle actuator having a movement range between a closed throttle and a fully opened throttle, said actuator comprising:
an electric, plural-coil DC motor having an output shaft;
a throttle return spring;
a gear transmission connected to the output shaft;
a control unit adapted to control power supply to the DC motor; and
a monitoring circuit adapted to monitor DC motor movement, wherein said
monitoring circuit is configured to:
receive signals from at least one voltage sensor adapted to sense voltage induced in at least one of the DC motor coils during a spring forced return of the throttle; and
create a representation of DC.

2. An actuator according to claim 1, wherein the
the at least one voltage sensor is configured to measure momentarily the voltage induced in at least one of the DC motor coils; and
the monitoring circuit is configured to produce a momentary representation of the amplitude of the voltage measured by said voltage sensor to diagnose the spring.

3. An actuator according to claim 1, wherein
the control unit comprises a bridge circuit comprising a plurality of branches, with one branch connected to each one of the coils.

4. An actuator according to claim 3, wherein
each branch of said branch circuit comprises a transistor switch connected to each one of the coils.

5. An actuator according to claim 1, wherein
the monitoring circuit is configured to compare measured rotational speed values of the DC motor to stored rotational speed profiles.

6. An actuator according to claim 1, wherein
the monitoring circuit is configured to compare measured angular throttle position values to stored throttle position profiles.

7. A method of controlling a spring return throttle actuator having a movement range between a closed throttle and a fully opened throttle, wherein the actuator comprises an electric, plural-coil DC motor having an output shaft, a throttle return spring, a gear transmission connected to the output shaft, a control unit adapted to control power supply to the DC motor and a monitoring circuit comprising a voltage sensor, said method comprising:
monitoring movement of the DC motor using the monitoring circuit;
sensing a voltage induced in at least one of the DC motor coils during a spring forced return of the throttle using the voltage sensor of the monitoring circuit; and
creating a representation of the DC motor movement.

8. A method according to claim 7, wherein the DC motor comprises three coils, and wherein the
voltage induced in at least one of the DC motor coils is sensed.

9. A method according to claim 7, further comprising
supplying the DC motor coils with power from each branch of a bridge circuit comprised in the control unit.

10. A method according to claim 7 further comprising
measuring rotational speed values of the DC motor and comparing the measured rotational speed values to stored rotational speed profiles.

11. A method according to claim 7
further comprising measuring angular throttle position values and comparing the measured angular throttle position values to stored throttle position profiles.

12. A throttle assembly comprising a throttle and a spring return throttle actuator, having a movement range between a closed throttle and a fully opened throttle, said actuator comprising:
an electric, plural-coil DC motor having an output shaft;
a throttle return spring;
a gear transmission connected to the output shaft;
a control unit adapted to control power supply to the DC motor; and
a monitoring circuit adapted to monitor DC motor movement, wherein said monitoring circuit is configured to:
receive signals from at least one voltage sensor adapted to sense voltage induced in at least one of the DC motor coils during a spring forced return of the throttle; and
create a representation of DC motor movement based on said signals.

13. A throttle assembly according to claim 12, wherein:
the voltage sensor is configured to measure momentarily the voltage induced in at least one of the DC motor coils; and
the monitoring circuit is configured to produce a momentary representation of the amplitude of the voltage measured by said voltage sensor to diagnose the spring.

14. A throttle assembly according to claim 12, wherein the control unit comprises a bridge circuit comprising a plurality of branches, with one branch connected to each one of the coils.

15. A throttle assembly according to claim 14, wherein each branch of said branch circuit comprises a transistor switch connected to each one of the coils.

16. A throttle assembly according to claim 12, wherein the monitoring circuit is configured to compare measured rotational speed values of the DC motor to stored rotational speed profiles.

17. A throttle assembly according to claim 12, wherein the monitoring circuit is configured to compare measured angular throttle position values to stored throttle position profiles.
